(19) United States
(12) Patent Application Publication
(10) Pub. No.: US 2011/0037992 A1
(43) Pub. Date: Feb. 17, 2011

(54) IMAGE FORMING APPARATUS, IMAGE FORMING METHOD, AND SYSTEM

(75) Inventor: Atsushi Kato, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/850,852

(22) Filed: Aug. 5, 2010

Related U.S. Application Data
(60) Provisional application No. 61/232,873, filed on Aug. 11, 2009.

(51) Int. Cl. G06F 3/12; G06K 15/00

(52) U.S. Cl. 358/1.13; 358/1.14

(57) ABSTRACT

According to one embodiment, an image forming apparatus having, in addition to a printing function, at least one of a copying function, a scanner function, and a facsimile function includes a setting-file generating unit configured to collect data concerning setting items necessary for the operation of the functions of the image forming apparatus and encrypt data of a predetermined setting item to generate a setting file, and a setting-file reflecting unit configured to decrypt the data of the predetermined setting item on the basis of the generated setting file and restore the setting items necessary for the operation of the functions.

### CROSS-REFERENCE TO RELATED APPLICATIONS

This application is based upon and claims the benefit of U.S. Provisional Application No. 61/232,873, filed on Aug. 11, 2009; the entire contents of each of which are incorporated herein by reference.

### FIELD

Embodiments described herein relate generally to an image forming apparatus, an image forming method, and a system.

### BACKGROUND

A MFP (Multi-Function Peripheral) as a type of an image forming apparatus is a digital complex machine that realizes, in addition to a printing function, plural functions such as a copying function, a scanner function, a facsimile function, and an image data storing function.

When the MFP breaks down or the operation of the MFP is abnormal, setting information necessary for the operation of the functions of the MIT set therein is restored to a setting state in the past to investigate a cause of the failure or realize recovery from the abnormal state.

It is necessary to cope with the restoration of the setting information taking into account various conditions. For example, it is necessary to consider that setting information used for restoration of a certain MFP is not only setting information of the MFP but also setting information of other MFPs. The setting information includes information peculiar to the MFP and information not depending on the MFP and further includes information that should be prevented from leaking. Therefore, there is a demand for a technique that can appropriately perform restoration of setting information to be adapted to various cases.

### BRIEF DESCRIPTION OF THE DRAWINGS

FIG. 1 is an exemplary perspective view of the schematic shape of the MFP 201 according to an embodiment;

FIG. 2 is an exemplary diagram of a configuration of an image forming system according to the embodiment;

FIG. 3 is an exemplary block diagram of the configuration of a control system of the MFP 201 according to the embodiment;

FIG. 4 is an exemplary flowchart for explaining a setting file creating procedure by the setting-file creating unit 22 according to the embodiment;

FIG. 5 is an exemplary diagram of setting items according to the embodiment;

FIG. 6 is an exemplary diagram of the structure of the setting file according to the embodiment;

FIG. 7A is an exemplary diagram for explaining cases in which setting information is restored according to the embodiment;

FIG. 7B is an exemplary diagram for explaining cases in which setting information is restored according to the embodiment;

FIG. 8 is an exemplary flowchart for explaining a procedure for reflecting a setting file according to the embodiment; and

FIG. 9 is an exemplary diagram of a setting screen 40 displayed on the display according to the embodiment.

### DETAILED DESCRIPTION

In general, according to one embodiment, an image forming apparatus having, in addition to a printing function, at least one of a copying function, a scanner function, and a facsimile function includes: a setting-file generating unit configured to collect data concerning setting items necessary for the operation of the functions of the image forming apparatus and encrypt data of a predetermined setting item to generate a setting file; and a setting-file reflecting unit configured to decrypt the data of the predetermined setting item on the basis of the generated setting file and restore the setting items necessary for the operation of the functions.

Embodiments are explained below with reference to a MFP 201 as an example of an image forming apparatus.

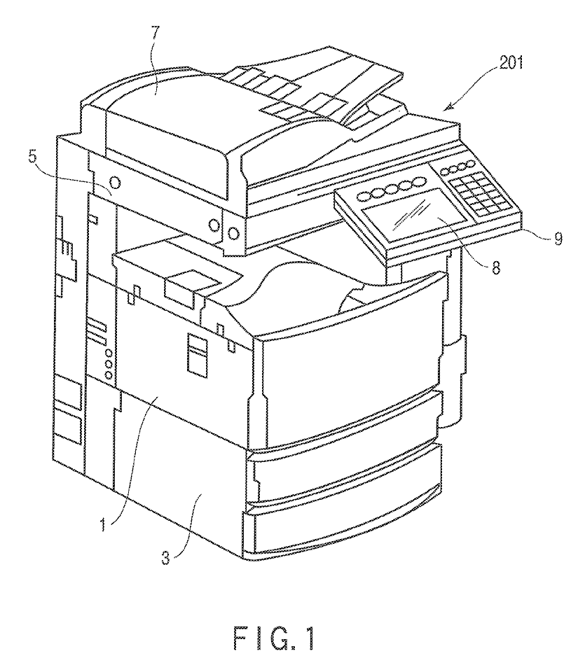

FIG. 1 is an exemplary perspective view of the schematic shape of the MFP 201 according to an embodiment.

The MFP 201 includes a print unit 1, a sheet tray 3, a scan unit 5, an auto feed unit 7, and an operation panel 9 including a display unit 8.

The print unit 1 outputs image information as an output image called, for example, hardcopy or printout. The sheet tray 3 feeds, to the print unit 1, an output medium, which is a sheet of an arbitrary size used for image output. The scan unit 5 captures image information as image data from an original document. The auto feed unit 7 delivers the original document, for which reading ends, from a reading position to a discharge position and guides the next original document to the reading position. The operation panel 9 is an instruction input unit for instructing the operation of the MFP 201 such as the start of image formation in the print unit 1 and the start of reading of image information of an original document by the scan unit 5. The display unit 8 for inputting an instruction and displaying information to an operator is provided on the operation panel 9.

The MFP 201 can be connected to an external information processing apparatus via a network or a communication line to receive various kinds of information.

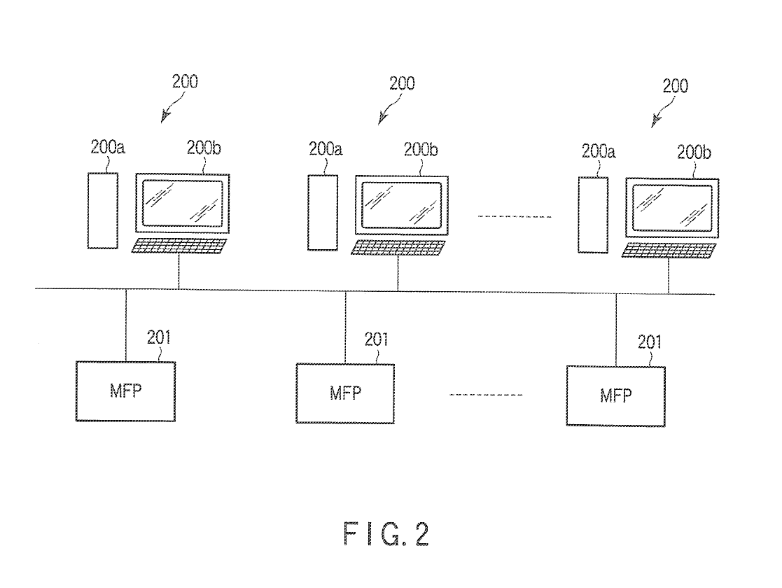

FIG. 2 is an exemplary diagram of a configuration of an image forming system according to the embodiment. The image forming system includes at least one PC (Personal Computer) 200 and at least one MFP 201, which are connected via a network 202.

The PC 200 is a data processing apparatus configured to exchange information with the MFP 201. The PC 200 includes a processing unit 200a and an input and output device 200b. The processing unit 200a includes a CPU (Central Processing Unit) and executes information processing. The input and output device 200b includes a display. The input and output device 200h passes an instruction input from a user to the processing unit 200a and displays output information from the processing unit 200a on a screen.

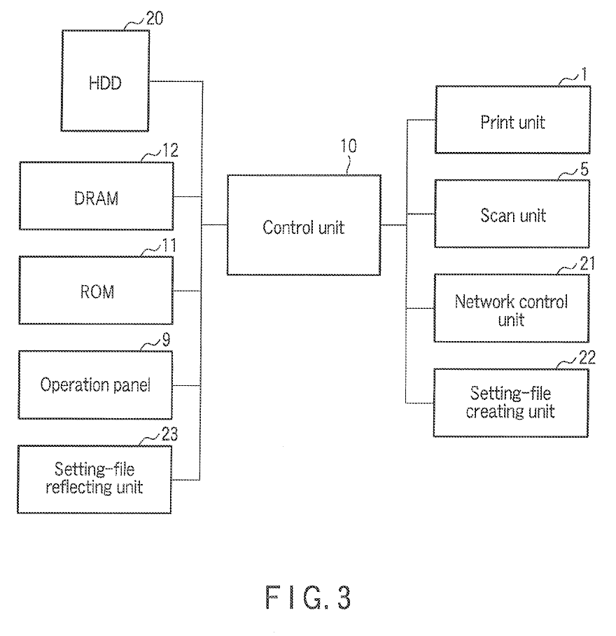

FIG. 3 is an exemplary block diagram of the configuration of a control system of the MFP 201 according to the embodiment.

The MFP 201 includes, together with the print unit 1, the scan unit 5, the operation panel 9, and a control unit 10, a ROM 11, a DRAM 12, an internal storage device (HDD) 20, a network control unit 21, a setting-file creating unit 22, and a setting-file reflecting unit 23. These units are connected via a system bus.

The control unit 10 controls the hardware units connected via the system bus. The ROM 11 stores various control programs and data necessary for the MFP 201 to operate. The DRAM 12 is a buffer memory configured to temporarily store data generated when the control programs are executed. The DRAM 12 is a volatile memory. Data stored in the DRAM 12 is erased by turning off a power supply.

The network control unit 21 exchanges information via a network such as the Internet. The HDD 20 is a nonvolatile storage medium set on the inside of the MFP 201. The setting-file creating unit 22 collects information and data representing a setting state of the MFP 201 and creates and stores a setting file. The setting-file reflecting unit 23 restores, on the basis of the setting file, the data representing the setting state of the MFP 201.

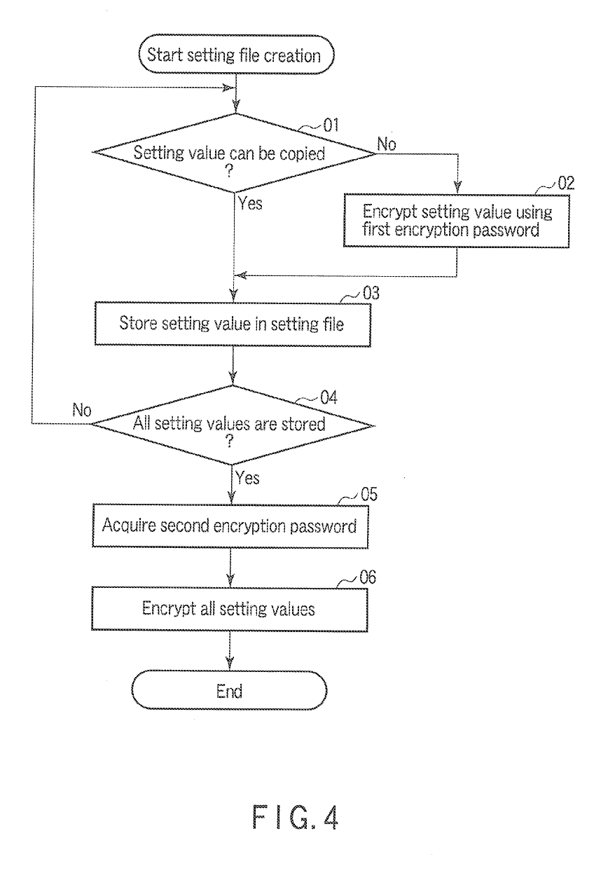

FIG. 4 is an exemplary flowchart for explaining a setting file creating procedure by the setting-file creating unit 22 according to the embodiment. A user who handles the setting file is not a general user but a serviceperson who is in charge of maintenance of the MFP 201.

When the MFP 201 receives an instruction for creating a setting file from the PC 200, the setting-file creating unit 22 starts operation. In Act 01, the setting-file creating unit 22 searches through the units of the MFP 201 to extract data corresponding to a predetermined setting item. The setting-file creating unit 22 checks whether the setting item can be copied, i.e., copying of the setting item is permitted.

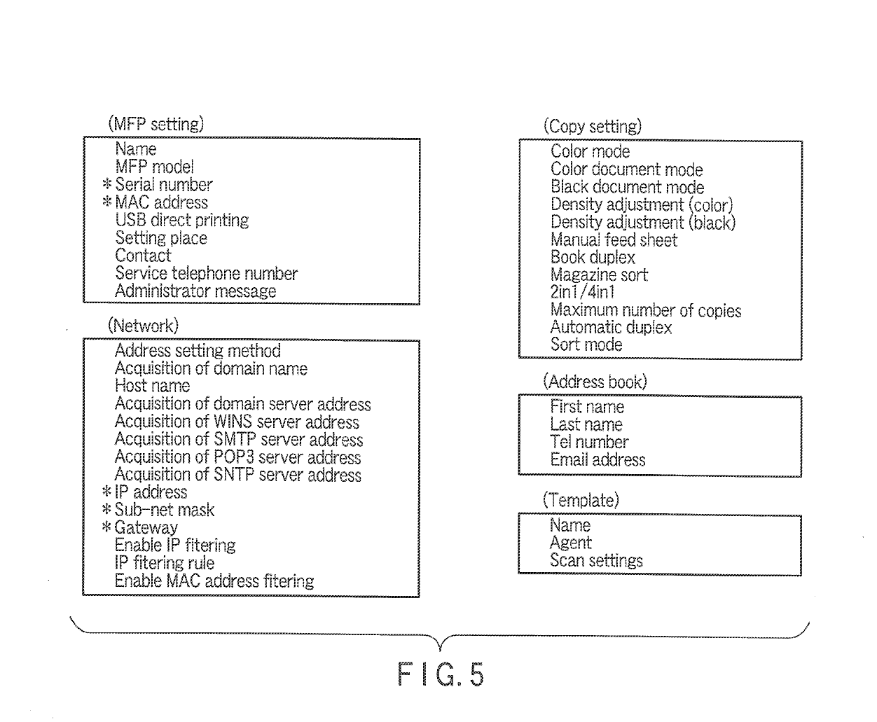

FIG. 5 is an exemplary diagram of setting items according to the embodiment. The setting items shown in FIG. 5 are classified into “MFP setting”, “network”, “copy setting”, “address book”, and “template”. Among the setting items shown in FIG. 5, setting items marked “*” are prohibited from being copied. The copy-prohibited setting items can be designated for each of a plurality of the MFPs 201. In the example shown in FIG. 5, information for specifying the MFP 201 is designated as the copy-prohibited setting items.

In the case of No in Act 01 in FIG. 4, i.e., if the setting item is copy-prohibited, in Act 02, the setting-file creating unit 22 encrypts a value of the setting item (a setting value). As a method of the encryption, a publicly-known technique only has to be used. As a first encryption password used in the encryption, a setting value peculiar to the MFP 201 set in advance is used. For example, as the first encryption password, a serial number of the MFP 201 as a peculiar setting value is used. Therefore, the first encryption password is data set on the inside of the MFP 201.

In Act 03, the setting-file creating unit 22 stores, in the setting file, the setting value encrypted by using the first encryption password. In the case of Yes in Act 01, i.e., if the copying of the setting value is permitted, in Act 03, the setting-file creating unit 22 directly stores the setting value in the setting file without encrypting the setting value.

FIG. 6 is an exemplary diagram of the structure of the setting file according to the embodiment. In the setting file, a “setting value” and an “encryption flag” are provided for each of setting items. If the “encryption flag” is OFF, the “setting value” is not encrypted. If the “encryption flag” is ON, the “setting value” is a value obtained by encrypting a value of the setting item.

In the case of No in Act 04 in FIG. 4, i.e., setting values are not stored in the setting file yet for all the setting items, the setting-file creating unit 22 repeats the processing from Act 01. In the case of Yes in Act 04, i.e., if setting values are stored in the setting file for all the setting items, in Act 05, the setting-file creating unit 22 acquires a second encryption password from the PC 200. For example, if setting values are stored in the setting file for all the setting items in Act 04, the setting-file creating unit 22 requests the PC 200 to transmit the second encryption password and acquires the second encryption password as a reply to the request. In Act 06, the setting-file creating unit 22 encrypts all the setting values of the setting file using the acquired second encryption password.

The second encryption password is a value set and input by the user in the PC 200. Before starting the operation in Act 01, the setting-file creating unit 22 may receive the second encryption password from the PC 200 together with an instruction for creating a setting file.

In any of the cases, if the second encryption password is not transmitted from the PC 200, the setting-file creating unit 22 does not carry out the encryption of all the setting values in Act 06. In that case, the setting-file creating unit 22 records, in the setting file, information indicating that the encryption of all the setting values is not carried out.

An encryption system employing the first encryption password and an encryption system employing the second encryption password may be different systems. The setting file is created for each of the MFPs 201 and stored in the HDD 20 by the processing explained above.

A method of restoring setting information of the MFP 23 using the stored setting file is explained below.

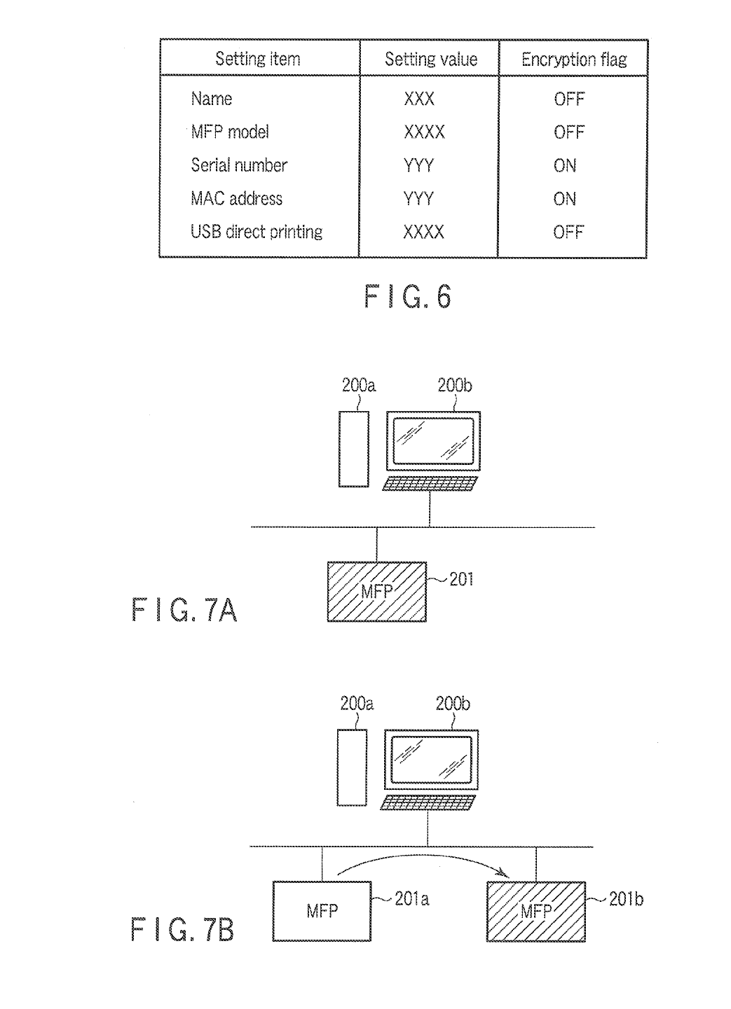

FIGS. 7A and 7B are exemplary diagrams for explaining cases in which setting information is restored according to the embodiment. In the case shown in FIG. 7A, the user instructs, from the PC 200, the MFP 201 to restore setting information using a setting file of the MFP 201. The MFP 201 restores the setting information using the setting file. In the case shown in FIG. 7B, the user acquires, from the PC 200, a setting file of a MFP 201a and transmits the setting file to a MFP 201b. The user instructs the MFP 201b to restore setting information using the setting file of the MFP 201a. The MFP 201b restores the setting information using the setting file of the MFP 201a.

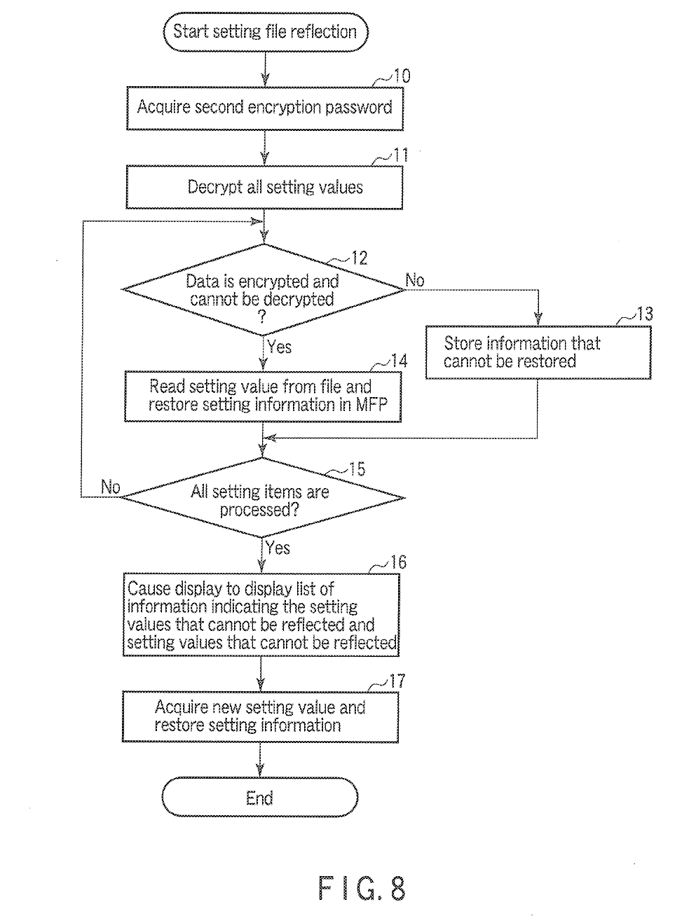

FIG. 8 is an exemplary flowchart for explaining a procedure for reflecting a setting file according to the embodiment. In Act 10, when, the PC 200 transmits an instruction for restoring setting information and the second encryption password to the MFP 201, in the MFP 201, the setting-file reflecting unit 23 starts and executes processing.

In Act 11, the setting-file reflecting unit 23 searches through data of a setting file and checks whether all setting values are encrypted. If all the setting values are encrypted, the setting-file reflecting unit 23 decrypts all the setting values of the setting file using the second encryption password. If not all the setting values are encrypted, the setting-file reflecting unit 23 directly proceeds to Act 12.

In Act 12, the setting-file reflecting unit 23 checks whether decryption is possible for en encrypted setting item among setting items of the setting file. Specifically, the setting-file reflecting unit 23 executes decryption processing using a peculiar setting value of the MFP 201, which is the first encryption password, for example, a serial number of the MFP 201 itself and checks whether the setting item is decrypted.

In the case of Yes in Act 12, i.e., if the setting item cannot be decrypted, the first encryption password is considered to be not correct. This is considered to be because the peculiar setting value of the MFP 201 used as the first encryption password in the case explained with reference to FIG. 7A is rewritten to a wrong value. This is also considered to be because, in the case explained with reference to FIG. 7B, the user is attempts to decrypt the setting information using a setting file of another MFP 201. Therefore, in Act 13, the setting-file reflecting unit 23 stores the setting item and the setting value that cannot be decrypted.

In the case of No in Act 12, i.e., if the setting item is not encrypted or the setting item can be decrypted by using the peculiar setting value of the MFP 201, which is the first encryption password, in Act 14, the setting-file reflecting unit 23 restores the setting information of the MFP 201 using the setting value.

In Act 15, the setting-file reflecting unit 23 checks whether all the setting items of the setting file are processed. In the case of No in Act 15, i.e., if the setting item that should be processed still remains, the setting-file reflecting unit 23 repeatedly executes the processing from Act 12. In the case of Yes in Act 15, i.e., if all the setting items are processed, the setting-file reflecting unit 23 executes processing in Act 16.

In Act 16, the setting-file reflecting unit 23 transmits, to the PC 200, information indicating that the setting values cannot be reflected and the setting value that cannot be reflected. The PC 200 edits the transmitted information and displays the information on the display of the input and output device 200b.

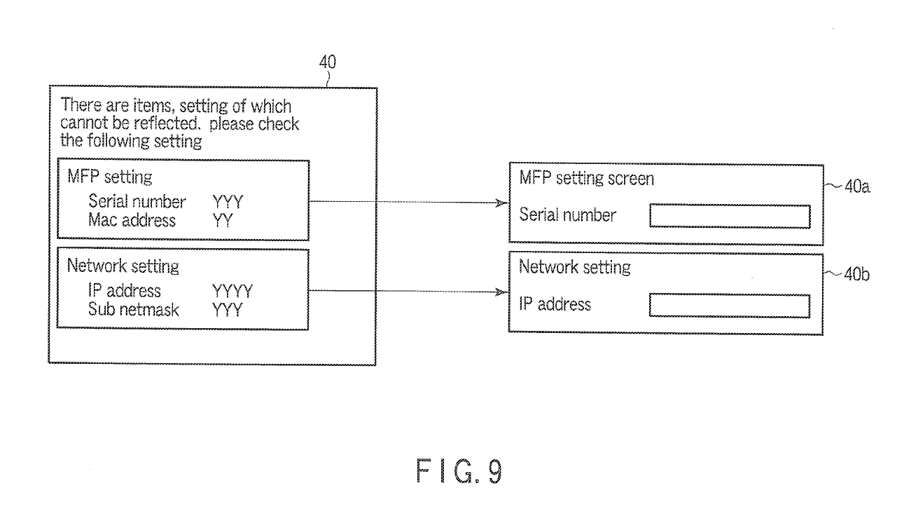

FIG. 9 is an exemplary diagram of a setting screen 40 displayed on the display according to the embodiment. The information indicating that the setting values cannot be reflected and the setting values that cannot be reflected are displayed on the setting screen 40. When the user selects setting items that the user desires to set, setting screens 40a and 40b concerning the setting items are displayed. When the user inputs setting values, the values are transmitted to the MFP 201. In Act 17 in FIG. 8, the MFP 201 restores the setting information of the MFP 201 using the transmitted values.

The user may retrieve information to be managed and input setting values to the setting screens 40a and 40b by performing separate operation or may decrypt values displayed on the setting screen 40 using a decryption processing device, which the user separately owns, to obtain setting values and input the setting values to the setting screens 40a and 40b.

After restoring the setting information, the user desirably performs operation to create and store a setting file at appropriate timing.

The embodiment explained above can be modified to various forms.

(1) In the embodiment, the user gives an instruction to the MFP from the PC. However, the user may give an instruction to the MFP from the operation panel provided in the MFP.

(2) A MFP may be selected out of plural. MFPs and provided as a representative MFP. The representative MFP may have the functions of the PC.

(3) In the embodiment, the setting files are stored in the respective MFPs. However, the setting files may be collectively stored in one PC or one MFP.

These various forms can be combined as appropriate.

The MFP according to the embodiment explained above realizes remarkable effects compared with the technique in the past.

In the MFP according to this embodiment, not only setting information of the MFP but also setting information of the other MFPs can be used as setting information used for restoration of the MFP. Since the setting information is double-encrypted, it is possible to prevent leakage of information. The embodiment can be applied to both of a system in which PCs and MFPs are combined and a system including only MFPs. Therefore, it is possible to appropriately perform restoration of setting information to be adapted to various cases.

The functions explained in the embodiment may be implemented by using hardware or may be realized by causing a computer to read a computer program in which the functions are described by using software. The functions may be implemented by selecting the software or the hardware as appropriate.

Further, the functions can also be realized by causing the computer to read a computer program stored in a not-shown recording medium. A recording format of the recording medium in this embodiment may be any form as long as the recording medium is a recording medium that can record the computer program and is computer-readable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus having, in addition to a printing function, at least one of a copying function, a scanner function, and a facsimile function, the image forming apparatus comprising:
a setting-file generating unit configured to collect data concerning setting items necessary for operation of the functions of the image forming apparatus and encrypt data of a predetermined setting item to generate a setting file; and
a setting-file reflecting unit configured to decrypt the data of the predetermined setting item on the basis of the generated setting file and restore the setting items necessary for the operation of the functions.

2. The apparatus according to claim 1, wherein the setting-file generating unit includes:
a determining unit configured to determine whether a setting item can be copied;
a first encrypting unit configured to encrypt, concerning a setting item prohibited from being copied, a setting value using predetermined peculiar information, which is set in the image forming apparatus, as a first encryption password; and
a generating unit configured to generate a setting file using the encrypted setting value, a setting value concerning a setting item permitted to be copied, and information indicating whether the setting value is encrypted.

3. The apparatus according to claim 2, wherein the setting-file reflecting unit includes:
a first decrypting unit configured to decrypt, concerning an encrypted setting item of the setting file, a setting value using the predetermined peculiar information set in the image forming apparatus; and
a first restoring unit configured to restore the data of the setting items necessary for the operation of the functions using the setting value decrypted by the first decrypting unit and a setting value concerning a setting item not encrypted.

4. The apparatus according to claim 3, wherein the setting-file reflecting unit further includes:
an output unit configured to output information including a setting value that cannot be decrypted by the first decrypting unit in order to display the information;
an acquiring unit configured to acquire a new setting value obtained by decrypting the setting value that cannot be decrypted; and
a second restoring unit configured to restore, using the new setting value, data of a setting item corresponding to the setting value.

5. The apparatus according to claim 1, wherein the setting-file generating unit includes:
a determining unit configured to determine whether a setting item can be copied;
a first encrypting unit configured to encrypt, concerning a setting item prohibited from being copied, a setting value using predetermined peculiar information, which is set in the image forming apparatus, as a first encryption password;
a generating unit configured to generate a setting file using the encrypted setting value, a setting value concerning a setting item permitted to be copied, and information indicating whether the setting value is encrypted; and
a second encrypting unit configured to encrypt all setting values of the generated setting file using an acquired second encryption password.

6. The apparatus according to claim 5, wherein the setting-file reflecting unit includes:
a second decrypting unit configured to execute decryption processing on all the setting values of the setting file using the second encryption password to be designated;
a first decrypting unit configured to decrypt, concerning an encrypted setting item of the decrypted setting file, a setting value using the predetermined peculiar information set in the image forming apparatus; and
a first restoring unit configured to restore the data of the setting items necessary for the operation of the functions using the setting value decrypted by the first decrypting unit and a setting value concerning a setting item not encrypted.

7. The apparatus according to claim 6, wherein the setting-file reflecting unit further includes:
an output unit configured to output information including a setting value that cannot be decrypted by the first decrypting unit in order to display the information;
an acquiring unit configured to acquire a new setting value obtained by decrypting the setting value that cannot be decrypted; and
a second restoring unit configured to restore, using the new setting value, data of a setting item corresponding to the setting value.

8. An image forming method for an image forming apparatus having, in addition to a printing function, at least one of a copying function, a scanner function, and a facsimile function, the image forming method comprising:
collecting data concerning setting items necessary for operation of the functions of the image forming apparatus and encrypting data of a predetermined setting item to generate a setting file; and
decrypting the data of the predetermined setting item on the basis of the generated setting file and restoring the setting items necessary for the operation of the functions.

9. The method according to claim 8, wherein the generating a setting file includes:
determining whether a setting item can be copied;
encrypting, concerning a setting item prohibited from being copied, a setting value using predetermined peculiar information, which is set in the image forming apparatus, as a first encryption password; and
generating a setting file using the encrypted setting value, a setting value concerning a setting item permitted to be copied, and information indicating whether the setting value is encrypted.

10. The method according to claim 9, wherein the restoring the setting items includes:
decrypting, concerning an encrypted setting item of the setting file, a setting value using the predetermined peculiar information set in the image forming apparatus; and
restoring the data of the setting items necessary for the operation of the functions using the decrypted setting value and a setting value concerning a setting item not encrypted.

11. The method according to claim 10, wherein the restoring the setting items further includes:
outputting information including a setting value that cannot be decrypted in order to display the information;
acquiring a new setting value obtained by decrypting the setting value that cannot be decrypted; and
restoring, using the new setting value, data of a setting item corresponding to the setting value.

12. The method according to claim 8, wherein the generating a setting file includes:
determining whether a setting item can be copied;
encrypting, concerning a setting item prohibited from being copied, a setting value using predetermined peculiar information, which is set in the image forming apparatus, as a first encryption password;
generating a setting file using the encrypted setting value, a setting value concerning a setting item permitted to be copied, and information indicating whether the setting value is encrypted; and
encrypting all setting values of the generated setting file using an acquired second encryption password.

13. The method according to claim 12, wherein the restoring the setting items includes:
executing decryption processing on all the setting values of the setting file using the second encryption password to be designated;
decrypting, concerning an encrypted setting item of the decrypted setting file, a setting value using the predetermined peculiar information set in the image forming apparatus; and
restoring the data of the setting items necessary for the operation of the functions using the decrypted setting value and a setting value concerning a setting item not encrypted.

14. The method according to claim 13, wherein the restoring the setting items further includes:
outputting information including a setting value that cannot be decrypted in order to display the information;
acquiring a new setting value obtained by decrypting the setting value that cannot be decrypted; and
restoring, using the new setting value, data of a setting item corresponding to the setting value.

15. An image forming system comprising:
at least one information processing apparatus; and
at least one image forming apparatus having, in addition to a printing function, at least one of a copying function, a scanner function, and a facsimile function, wherein
the information processing apparatus includes:
a creation instructing unit configured to transmit an instruction for creating a setting file to the image forming apparatus; and
a reflection instructing unit configured to transmit an instruction for reflecting a setting file to the image forming apparatus, and
the image forming apparatus includes:
a setting-file generating unit configured to collect, according to the instruction for creating a setting file, data concerning setting items necessary for operation of the functions of the image forming apparatus and encrypt data of a predetermined setting item to generate a setting file; and
a setting-file reflecting unit configured to decrypt, according to the instruction for reflecting a setting file, the data of the predetermined setting item on the basis of the generated setting file and restore the setting items necessary for the operation of the functions.

16. The system according to claim 15, wherein the setting-file generating unit of the image forming apparatus includes:
a determining unit configured to determine whether a setting item can be copied;
a first encrypting unit configured to encrypt, concerning a setting item prohibited from being copied, a setting value using predetermined peculiar information, which is set in the image forming apparatus, as a first encryption password; and
a generating unit configured to generate a setting file using the encrypted setting value, a setting value concerning a setting item permitted to be copied, and information indicating whether the setting value is encrypted.

17. The system according to claim 16, wherein the setting-file reflecting unit of the image forming apparatus includes:
a first decrypting unit configured to decrypt, concerning an encrypted setting item of the setting file, a setting value using the predetermined peculiar information set in the image forming apparatus; and
a first restoring unit configured to restore the data of the setting items necessary for the operation of the functions using the setting value decrypted by the first decrypting unit and a setting value concerning a setting item not encrypted.

18. The system according to claim 17, wherein the setting-file reflecting unit further includes:
an output unit configured to output information including a setting value that cannot be decrypted by the first decrypting unit in order to display the information;
an acquiring unit configured to acquire a new setting value obtained by decrypting the setting value that cannot be decrypted; and
a second restoring unit configured to restore, using the new setting value, data of a setting item corresponding to the setting value.

19. The system according to claim 15, wherein
the information processing apparatus further includes a password transmitting unit configured to transmit a second encryption password to the image forming apparatus, and
the setting-file generating unit of the image forming apparatus includes:
a determining unit configured to determine whether a setting item can be copied;
a first encrypting unit configured to encrypt, concerning a setting item prohibited from being copied, a setting value using predetermined peculiar information, which is set in the image forming apparatus, as a first encryption password;
a generating unit configured to generate a setting file using the encrypted setting value, a setting value concerning a setting item permitted to be copied, and information indicating whether the setting value is encrypted; and
a second encrypting unit configured to encrypt all setting values of the generated setting file using the acquired second encryption password.

20. The system according to claim 19, wherein the information processing apparatus includes:
a second decrypting unit configured to execute decryption processing on all the setting values of the setting file using the acquired second encryption password;
a first decrypting unit configured to decrypt, concerning an encrypted setting item of the decrypted setting file, a setting value using the predetermined peculiar information set in the image forming apparatus; and
a first restoring unit configured to restore the data of the setting items necessary for the operation of the functions using the setting value decrypted by the first decrypting unit and a setting value concerning a setting item not encrypted.
